(19) United States
(12) Patent Application Publication
(10) Pub. No.: US 2021/0055896 A1
(43) Pub. Date: Feb. 25, 2021

(54) ESTIMATING A NUMBER OF REMAINING IMPRESSIONS FOR A COMPONENT IN A PRINTING DEVICE

(71) Applicant: Hewlett-Packard Development Company, L.P., Spring, TX (US)

(72) Inventors: Vitaly Portnoy, Ness Ziona (IL); Michel Assenheimer, Ness Ziona (IL); Amiran Lavon, Ness Ziona (IL); Pinni Perlmutter, Ness Ziona (IL)

(73) Assignee: Hewlett-Packard Development Company, L.P., Spring, TX (US)

(21) Appl. No.: 16/964,764

(22) PCT Filed: Mar. 26, 2018
(86) PCT No.: PCT/US2018/024291

§ 371 Date: Jul. 24, 2020

(51) Int. Cl. G06F 3/12; G06F 11/30; G06F 11/34; G03G 15/00

(52) U.S. Cl. CPC G06F 3/1229; G06F 11/3013; G03G 15/553; G06F 3/1203; G06F 11/3452

(57) ABSTRACT

An apparatus comprises a counter to determine a number of impressions already printed by a component in a printing device; and a controller, coupled to the counter, to use the number of impressions already printed and information relating to lifespan performance of the component in a printing device, to determine an estimated number of remaining impressions for the component, and to communicate the estimated number of remaining impressions to a user. The information relating to lifespan performance provides an indication of an estimated number of remaining impressions, for the number of impressions already printed, derived from statistical lifespan data selected in dependence on a lifespan threshold corresponding to the number of impressions already printed.

### BACKGROUND

There are several components in a printing device that support printing processes, and some of these may need to be replaced after they have been used for some time to ensure continued satisfactory operation of the printing device. However, operators may not have a good intuition about life expectancy of the components, and may therefore replace a significant number of components prematurely, long before a failure would have occurred.

### BRIEF DESCRIPTION OF THE DRAWINGS

FIG. 1 is a schematic diagram showing an example of components for a printing device;

FIG. 2 is a schematic diagram illustrating an example of apparatus that may be used with the components of FIG. 1;

FIG. 3 is a schematic diagram showing an example of a printing device;

FIG. 4 provides an example of a graphical user interface to communicate information to a user;

FIG. 5 shows an example of a look-up table for estimating a number of remaining impressions of a component;

FIG. 6 illustrates a graphical representation of an example of function for estimating a number of remaining impressions for a component;

FIG. 7 is an example flowchart of an operating method;

FIG. 8 is a graphical representation of an example of data that can be used to estimate a number of remaining impressions of a component;

FIG. 9 is an example flowchart of a method for calculating a conditional lifespan of a component; and

FIGS. 10 and 11 are example schematic diagrams illustrating the elements of a storage medium accessible by a processor which may be included in the apparatus of FIG. 2.

### DETAILED DESCRIPTION

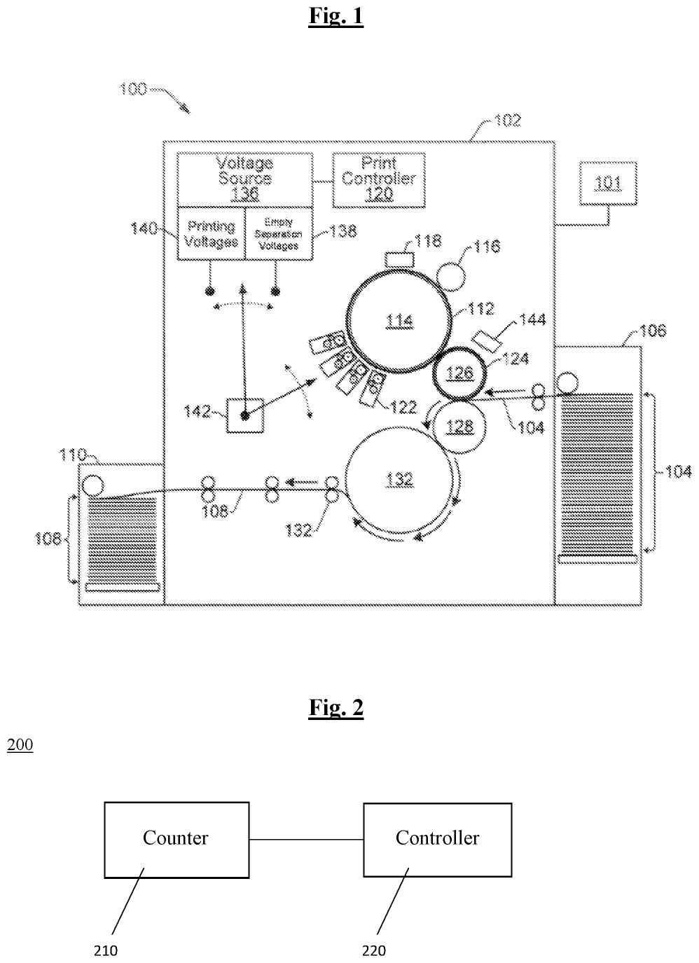

Referring to FIG. 1, example printing apparatus 100 for a printing device is shown. The example printing apparatus 100 comprises a plurality of components. The example printing apparatus 100 illustrated in FIG. 1 comprises a user interface 101, a print engine 102, a print target input mechanism 106 and a print target stacker tray 110. The print engine comprises a photoreceptor 112, an imaging drum 114, a charge roller 116, a laser imaging unit 118, a print controller 120, a binary ink developer (BID) 122, an image transfer blanket 124, an immediate transfer member (ITM) drum 126, an impression drum 128, rollers 132, a voltage source 136 providing empty separation voltages 138 and printing voltages 140, a voltage application mechanism 142, and a sensor 144. Printing operations will now be described briefly. The photoreceptor 112 may be a printing imaging plate (PIP). The photoreceptor 112 defines an outer surface of the imaging drum 114 on which images can be formed. The laser imaging unit 118 exposes the photoreceptor 112 to create an electrostatic charge pattern that replicates the image to be printed. The BID selectively develops ink onto the electrostatic charge pattern on the photoreceptor 112. The ink image developed on the photoreceptor 112 is transferred from the photoreceptor 112 to an image transfer blanket 124. The blanket 124 is wrapped around and securely fastened to the outer surface of the ITM drum 126. The ink on the blanket is heated and transferred from the blanket 124 to a print target such as a sheet 104 (e.g., cut-sheet or web paper), which is held or supported by an impression (IMP) drum/cylinder 128. The printed medium 108 is delivered via the rollers to the print target stacker tray 110. The print controller 120 can apply printing voltages 138, 140 from the voltage source 136 to the BID 122 through the voltage application mechanism 142 in order to control the printing operations. A sensor 144 may be located near the drum 126 to detect the number of revolutions of the ITM drum 126 and therefore the number of impressions printed by the printing apparatus 100.

Some of the components, such as the PIP, BID and blanket are replaced by the operator after a number of printing operations. The operator may replace them because they have failed or as preventive replacements, before they fail. Preventive replacements may take place as part of a procedure, such as at the start of a shift or at a break in the printing process. Another example of when preventive replacements take place is when operators anticipate that a defect is likely to occur in the near future.

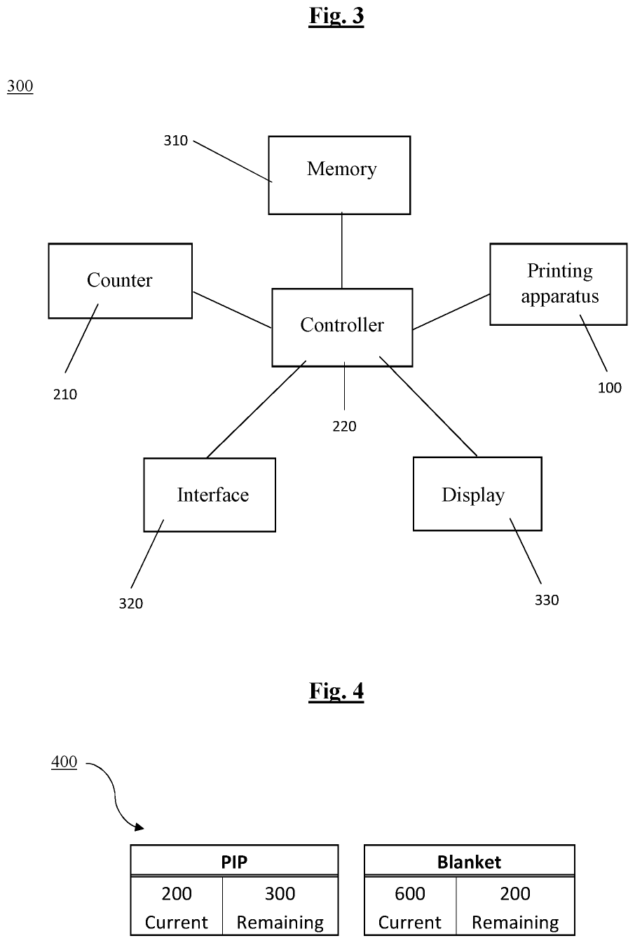

FIG. 2 is a schematic diagram illustrating an example of an apparatus 200 for use in a printing device to estimate a number of remaining impressions of a component of a printing device, such as a component of the printing apparatus of FIG. 1. The apparatus 200 comprises a counter 210 coupled to a controller 220. The counter 210 determines the number of impressions already printed. The controller 220 may then use the number of impressions already printed, along with information relating to lifespan performance of a component in the printing apparatus 100 to determine an estimated number of remaining impressions for the component. The controller 220 may also communicate the estimated number of remaining impressions to a user of the printing device 100, such as the operator. The information relating to lifespan performance comprises information derived from conditional lifespan data. In more detail, the information relating to lifespan performance provides an indication of an estimated number of remaining impressions derived from statistical lifespan data selected in dependence on a lifespan threshold corresponding to the number of impressions already printed. The controller 220 uses the indication of an estimated number of remaining impressions to determine the estimated number of remaining impressions for the component. Lifespans shorter than the number of impressions already printed are removed from the statistical lifespan data from which the indication of a remaining number of impressions is derived. In some examples, by using conditional lifespan data, the sum of the estimated number of remaining impressions and the impressions already printed increases as the impressions already printed increases. The apparatus can thereby be used to provide novel information to an operator for reducing preventive replacements.

In more detail, the information relating to lifespan performance provides a plurality of indications of estimated numbers of remaining impressions, each for a different number of already printed impressions. The selected statistical lifespan data may be selected from base information comprising statistical performance data for a plurality of printing devices. For example, it may comprise statistical performance data from the worldwide install base of the printing device and similar printing devices. It could also comprise additional data, such as lab data. A subset of the base information, selected in dependence on a lifespan threshold equal to the number of already printed impressions is used to derive an indication of an estimated number of impressions for that number of already printed impressions. A subset of the base information used for a determined number of already printed impressions may comprise the lifespans of replaced components that had lifespans equal to or higher than the lifespan threshold. As a specific example, at 30,000 printed impressions, all components which malfunctioned or were otherwise replaced before 30,000 impressions are excluded from the selected statistical lifespan data and the data merely contains replacements with lifespans of 30,0000 impressions and above. The metrics of this capped distribution is higher, compared to the distribution provided by the entire base information, because low lifespans are excluded from the data. A statistic of the lifespans of the replaced components with lifespans which reached at least 30,000 impressions is then computed and this is then used, at a later time, to provide the indication of the estimated number of remaining impressions for a current component with 30,000 already printed impressions.

In some examples, the information relating to lifespan performance may comprise pre-computed mapping information providing the indication of an estimated number of remaining impressions. The mapping information may have an input and an output and the output may be the indication of an estimated number of remaining impressions. The input may be a value based on the number of already printed impressions. The input may also comprise additional parameters. In some examples, the mapping information is provided in the form of a formula or a look-up table. The information relating to lifespan performance may further comprise additional predetermined adjusting data that is applied to the output of the mapping information to then obtain the estimated number of remaining impressions. Alternatively, the indication of the estimated number of impressions, output by the mapping information, is the actual estimated number of remaining impressions. The information relating to lifespan performance may also comprise additional predetermined adjusting data used to derive the input, from the number of already printed impressions, to the predetermined mapping information. This may include, if there are more than one input parameter to the mapping information, the adjusting data being used as one of those input parameters. Any updates to the information relating to lifespan performance of a component, for example due to changes in the base information, new manufacturer choices or new operator choices or historical use habits, may then be made via the adjusting data rather than having to re-compute the mapping information.

The counter 210 may receive signals from a sensor located near a drum, for example the sensor 144 described with respect to FIG. 1. The sensor may sense the angle of rotation of a drum, such as the ITM drum 126 of FIG. 1, and the counter may interpret the output of the sensor to determine when a full revolution of the drum has occurred. The counter can then increment a stored value each time the drum has turned and thereby count the number of impressions printed. The printing device may have non-printing cycles, when a component of the printing device is not ready to print. If the drum moves as part of a non-printing cycle, when no printing actually takes place, the counter may not increment the stored value. The counter may be informed about non-printing cycles by the print controller 120 mentioned with respect to FIG. 1. The counter 210 may send a signal to the controller 220 wherein the signal contains information regarding the number of impressions already printed. The number of impressions already printed is the number of impressions already printed by the component in the printing device. In other words, it is the number of actual printing cycles in which a particular component has already been involved, for example since the particular component was installed or replaced. Consequently, although FIG. 2 shows a single counter, if the printing device comprises more than one replaceable component, a separate counter may be provided for each replaceable component. Furthermore, when a component is replaced the counter for that component may reset to zero, such that the number of impressions printed by the new component can be determined. The counter may be implemented in software, as a set of instructions. When the counter is implemented in software and uses signals from an existing sensor, no new dedicated hardware may be needed to allow the counter 210 to determine the number of impressions printed. Although the counter has been described to receive signals from a sensor near the ITM drum 126, it can receive signals from any sensor which provides signals that can be used to count the number of impressions printed in the printing device.

The controller may comprise a processor and internal and/or external memory storing instructions and data, including the information relating to lifespan performance of the component, for determining the estimated number of remaining impressions. The controller may communicate the estimated number of remaining impressions to a user by displaying the remaining number of impressions on a display. Alternatively, it may communicate the estimated number of remaining impressions to a user in a different way.

The controller may monitor and estimate the number of remaining impressions for a plurality of components. Although FIG. 2 shows a single counter, if the printing device comprises a plurality of components that can be replaced, the controller may be coupled to a separate counter for each replaceable component. In some examples, the counters 210 and the controller 220 may form part of a main controller of a printing device.

FIG. 3 is a schematic diagram showing an example of a printing device 300. The printing device comprises the counter 210 and the controller 220 of FIG. 2. The printing device also comprises the printing apparatus 100 comprising the printing components described with respect to FIG. 1. The controller 220 is coupled to the printing apparatus 100 of FIG. 1. The controller 220 may be in communication with the print controller 120 of the printing components or the controller 220 and the print controller may form part of the same controller. The controller 220 is additionally coupled to a memory 310, an interface 320 and a display 330.

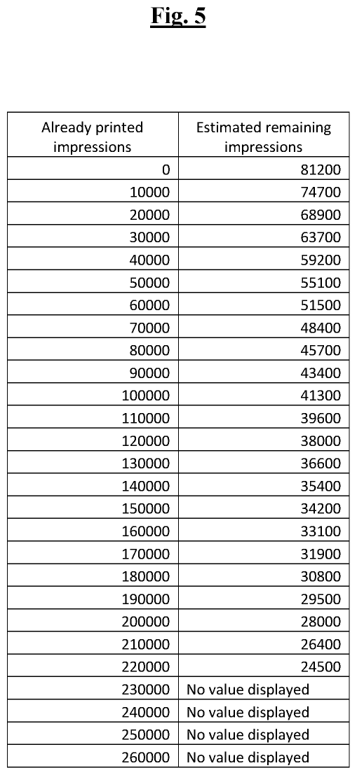

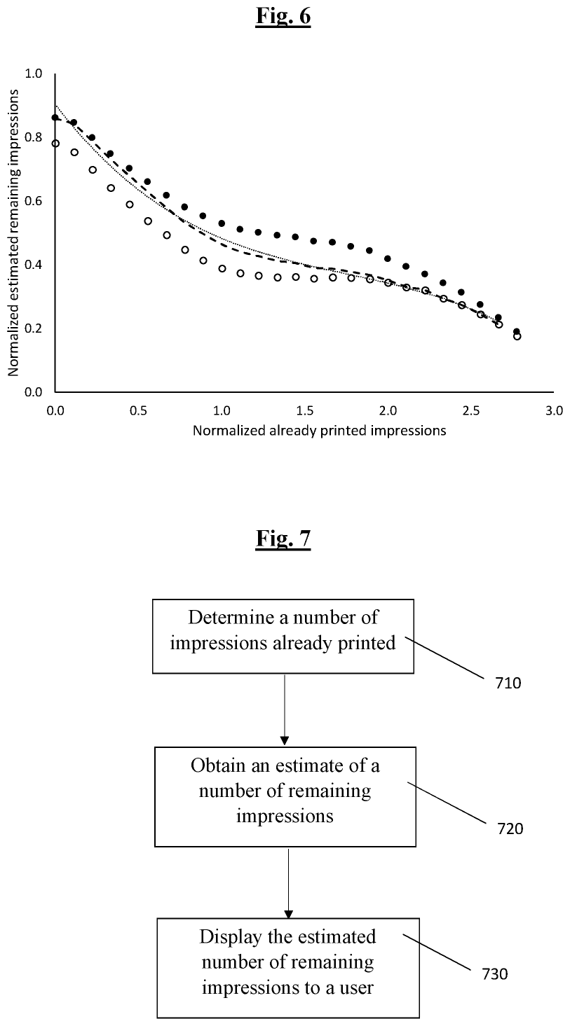

The memory 310 may be used to store the information relating to lifespan performance of a component in the printing device 100. In more detail, the memory 310 may store the predetermined mapping information and the predetermined adjusting data described with respect to FIG. 2. The stored mapping information may comprise a formula and/or a look-up table, as will be described in more detail with respect to FIGS. 5 and 6. As indicated above, the mapping information may be “universal” or common to a number of printing devices and the adjusting data may be used with the mapping information to obtain an estimated number of remaining impressions appropriate for that printing device. In this respect, the adjusting data can be used to ensure that the estimated number of remaining impressions is appropriate considering the historical performance of the specific printing device, in accordance with up to date statistical information and/or provided at a confidence level set by the operator or manufacturer for that particular printing device, but the adjusting data is not limited in this regard. Consequently, the adjusting data can be used to adapt the mapping information. By using mapping information common to a plurality of printing device and/or which is not regularly updated, the complexity of maintaining the information relating to lifespan performance of the component is reduced.

The adjusting data may be used together with the number of already printed impressions as an input to the mapping information. Additionally or alternatively, it may be used to adjust the output of the mapping information to obtain the estimated number of remaining impressions of a component of the printing device of FIG. 3. Additionally or alternatively, it could be used to select mapping information from a selection of mapping information stored in memory.

The adjusting data may comprise printing device performance data that is applied, by the controller 220, to the indication of an estimated number of remaining impressions, output by the mapping information, to obtain the estimated number of remaining impressions. The printing device performance data may be derived from historical performance data of the printing device. For example, the output of the mapping information may indicate the worldwide average of the relevant subset of the base information and local historical performance data for the printing device may indicate that the average life of a component of the printing device is twice that of the worldwide average. In those cases, the estimated number of remaining impressions, indicated by the output by the mapping information, may need to be doubled to give an accurate reflection of the likely number of remaining impressions for the component. The controller may multiply an output of the mapping information with the printing device performance data to obtain the likely number of remaining impressions for the component. In some examples, the printing device performance data may be the average of lifespans of the component recorded locally for the specific printing device. The printing device may store a log of lifespans of replaced components. When a component is replaced, the number of impressions in which the component was involved before it was replaced may be logged in this log. The printing device performance data may then be obtained from some or all of the lifespans in this log and may be updated when new replacements occur. In other examples, the printing device performance data may be a value or set of values computed taking various factors into account, such as the applications of the printing operations, print volume, historical start/stop patterns of the printing device and operator proficiency. Moreover, in some examples, the application of the adjusting data to an output of the mapping information may not be as simple as scaling the output of the mapping information. There may be a more complex relationship between the output of the mapping information and the appropriate estimated number of remaining impressions for the printing device. In some examples, the printing device performance data may be a look-up table or another formula.

The adjusting data may further comprise a statistical metric value derived from the base information. The controller may use the value to obtain the indication of an estimated number of remaining impressions. In more detail, the value may be used as an input to, or adjust the number of printed impressions before it is input into, the mapping information. In some examples, the input to the mapping information may be the ratio between the currently printed number of impressions and the statistical metric value. For example, the statistical metric may be a worldwide average lifespan calculated from the base information. Alternatively, the adjusting data may comprise a look-up table or formula for deriving the input to the mapping information.

As a specific example, the estimated remaining number of impressions Rₚₑᵣₛₒₙₐₗ may be determined as follows:

$${R}_{personal} = {P}_{n} ( \frac{P}{{LS}_{WW}} ) \times {LS}_{press} \qquad [ equation 1 ]$$

Where P is the number of already printed impressions, Pₙ is a polynomial function providing the mapping information, LS_{ww} is the worldwide average lifespan and LSₚᵣₑₛₛ is the average lifespan of the component for the printing device, forming the printing device performance data. As is clear from equation 1, the input to the formula Pₙ is the ratio of the number of printed impressions and the worldwide average lifespan. Moreover, the output of the formula, corresponding to the indication of an estimated number of remaining impression, is a normalized number of remaining impressions Rₙₒᵣₘ,

$${R}_{norm} = {P}_{n} ( \frac{P}{{LS}_{WW}} ) \qquad [ equation 2 ]$$

obtained from a relevant subset of the base information, which if multiplied by the worldwide average for the base information would give a generalized number of remaining impressions R

R=Rₙₒᵣₘ*LS_{ww}. [equation 3]

The estimated number of remaining impressions for the component of the printing device Rₚₑᵣₛₒₙₐₗ is then given by

$${R}_{personal} = {R}_{norm} * {LS}_{WW} * \frac{{LS}_{press}}{{LS}_{WW}} = {R}_{norm} * {LS}_{press} \qquad [ equation 4 ]$$

from which it can be seen that equation 1 can be derived.

The estimated number of remaining number of impressions has an associated confidence level. The confidence level may be pre-programmed by the manufacturer or it may be dynamically set by the manufacturer or operator. For example, the mapping information may indicate the median number of impressions remaining for a component of a printing device that has already printed a given number of impressions. Of course that means that 50% of the time the component will have additional impressions left to print compared to the estimated number and 50% of the time the component will have fewer impressions left to print before it fails. Consequently, an operator or manufacturer may want a higher confidence level. For example, the operator or manufacturer may want a 90% confidence level, meaning that there is a 9 out of 10 chance that a components will have a remaining number of impressions equal to or higher than the estimated number of remaining impressions indicated by the mapping information. In that case, the operator may want the output of the mapping information to be an indication of the 10th percentile instead of an indication of the median of the distribution. The operator or manufacturer may alternatively want a lower confidence level. The indication of the estimated number of remaining impressions may be an indication of any suitable metric for the distribution provided by the relevant subset of the base information, including the average, the median, a percentile or quantile of the distribution. If the mapping information is for example a polynomial, the coefficients of the polynomial may be selected to give the estimated number of remaining impressions at a chosen confidence level. If the mapping information is a look-up table, the entries in the look-up table are chosen to give the estimated number of remaining impressions at the chosen confidence level.

In some examples, the adjusting data may comprise information indicating a confidence level, for example, in the form of an additional input parameter to the mapping information or data indicating to the controller which mapping information to select. The controller 220 then determines the estimated number of remaining impressions, in accordance with the adjusting data, at the indicated confidence level. In the examples when the information indicating a confidence level is in the form of an input parameter to the mapping information, changing the confidence level does not involve any changes to the mapping information. In other examples, a plurality of formulas or look-up tables, one for each confidence level or a combination of confidence levels, may be stored. In yet other examples, a look-up table or formula may be dynamically created by the controller based on a selected confidence level or a combination of selected confidence levels.

In some examples, an operator may be able to select one or more target confidence levels using a graphical user interface on the display 330. A number of possible confidence levels, such as low, medium and high, may be stored in memory, together with a pointer to the associated adjusting data or mapping information. The memory may also store an indication of a confidence level selected by the operator, to allow the controller to access the relevant adjusting data or mapping information when it computes the estimated number of remaining impressions. In some examples, the mapping information may be derived to provide an indication of an estimated number of remaining impressions at a first confidence level for a first set of already printed impressions and at a different second confidence level for a second set of already printed impressions. The mapping information may be derived from first and second statistical metrics with the respective first and second confidence level and the output of the mapping information may transition from one to the other as the already number of impressions increases. The memory may then store two different selected indications of confidence levels. The combination of confidence levels may correspond to an input parameter or mapping information to be used. Alternatively, each confidence level may correspond to a different input parameter or mapping information to be used at different sets of already printed impressions. The derivation of the mapping information will be described in more detail below with respect to FIG. 6.

The adjusting data may further comprise data for rounding and interpolating. For example, the controller may use adjusting data to round a value obtained from the indication of an estimated number of remaining impressions, or to the indication itself, in order to obtain the estimated number of impressions to be communicated to the user. It has been described above that the sum of the estimated number of remaining impressions and the impressions already printed increases as the impressions already printed increases but this may not hold true for the estimated number of remaining impressions communicated to the user if that estimated number is a rounded estimate. The adjusting data may further comprise additional data not described herein. The mapping information and the adjusting data may instead or additionally be stored in a memory area on an external device, on a server, or in a cloud storage service, to be transmitted to, or otherwise retrieved by, the controller 220.

In some examples, updates may be made to the information related to lifespan performance when new statistical data is available, for example as a result of longer lifespans being recorded through use of the apparatus 200 described herein. Alternatively or additionally, changes may be made as a result of new user or manufacturer choices. The update information may comprise updates to the adjusting data while the mapping information stays the same. The interface 320 may receive update information to update information relating to lifespan performance of one or more components of the printing apparatus 100. The update information may then be stored in the memory 310, or in an external device. The interface may for example be an interface to receive and transmit information over a network, such as the internet or a local network, to a data processing apparatus such as a personal computer.

The display 330 may receive the estimated number of remaining impressions from the controller 220 and display this estimated number of remaining impressions to the user using a graphical user interface (GUI). The display may be a part of the printing device 300, as shown in FIG. 3, or may be located in a different device. The printing device may for example be a light-emitting diode (LED) touchscreen. The printing device may receive user instruction inputs via the touchscreen or from a separate user interface, such as the user interface 101 of the printing apparatus show in FIG. 1. The display may be separate to, or be combined with, the user interface 101 of the printing apparatus 100.

FIG. 4 is an example of a graphical user interface (GUI) 400 communicated to a user on the display 330. The GUI shows the name of one or more replaceable components of the printing apparatus 100 and the estimated number of remaining impressions of the one or more components. The GUI may further show the number of impressions already printed for each component, as determined by the counters 210. The GUI may show the information to be presented to the user as a table, with one field for the number of impressions already printed and one field for the estimated number of remaining impressions. The operator can then make a decision on when to replace a component based on the information displayed. The information displayed in the example of FIG. 4 simply displays the remaining number of impressions without any recommendations for when the component should be replaced to allow the operators to make their own decisions. In other words, the information is displayed in a manner void of judgment. In alternatively examples, the GUI may further include additional information, such as a color-coded scale or graph, which may include some level of interpretation and/or recommendations.

As a result of using conditional lifespan data, the estimated number of remaining impressions is one or greater. In other words, in examples, the methods used may not predict an end of the life of the component. If the component has not malfunctioned, the estimated number of remaining impressions will be at least one. However, in some examples, for very high number of printed impressions, no value may be shown for the estimated number of remaining impressions. This is because just a small number of components may have achieved such high numbers of printed impressions and the average, or other statistical metric value, calculated based on such a small subset of the base information may therefore not be reliable.

FIG. 5 is an example of a look-up table showing mapping information indicating a mapping between a plurality of numbers of printed impressions and a corresponding plurality of estimated numbers of remaining impressions for a component of the printing device 100. The left hand column include entries, providing the inputs to the table, corresponding to the number of already printed impressions and the right hand column include entries, providing the outputs from the table, for the corresponding indications of estimated numbers of remaining impressions. The controller 220 may use the look-up table along with the number of impressions already printed as determined by the counter 210 to determine an estimated number of remaining impressions. FIG. 5 shows that the inputs are the actual numbers of already printed impressions and the outputs are actual estimated numbers of remaining impressions. However, in other examples, adjusting data would need to be applied to the number of already printed impressions, to derive the input to the table, and/or to the output, to derive the estimated number of remaining impressions. There may be a separate look-up table for each separate replaceable components of the printing apparatus 100 stored in the memory 310 or on an external storage device, server, or cloud service. There may also be different look-up tables for different chosen confidence levels. As shown in FIG. 5, the look-up table may not store indications of estimated numbers of remaining impressions for every possible number of already printed impressions. Instead, the controller may round the number of impressions received from the counter to the nearest entry in the left hand column of the table. The controller may then interpolate from the values in the right hand column of the table to determine the estimated number of remaining impressions for an intermediate number of already printed impressions. The adjusting data may comprise data for carrying out rounding or interpolating.

At very high numbers of printed impressions, the statistical data may be unreliable and therefore no value may be displayed for the remaining number of impressions as indicated by the look-up table in FIG. 5. As mentioned above, this is because merely a small number of components may have achieved such high numbers of printed impressions and the average, or other statistical metric value, calculated from this small subset of the base information may therefore not be reliable.

FIG. 6 is an example of a graphical representation showing a calculation of an estimated number of remaining impressions and indicating how a formula, or look-up table, implementing the mapping information may be derived. The graph shows a normalized estimated number of remaining impressions for a set of data using two different statistical metrics against the normalized number of impressions already printed. In this example the two different statistical metrics used are a first statistical metric corresponding to the average (mean) and a second statistical metric corresponding to the median, and these are represented in the figure by closed and open circles respectively. The two different statistical metrics each give a different normalized value for the estimate of the number of remaining impressions of a component, and depending on the number of already printed impressions, a different statistical metric may be the most helpful one to communicate to a user. The different statistical metrics provide estimates to different confidence levels and a user may find it helpful to be informed of estimates that transition from one confidence level to another as the number of impressions already printed increases.

It will now be described how a formula, such as Pₙ in equation 1 described hereinbefore, or a look-up table, to be used in the printing device to estimate the number of remaining impressions can be derived from statistical metric values such as those shown in FIG. 6. The dashed line in FIG. 6 shows a line which indicates an estimated number of remaining impressions based upon the two different statistical metrics. The dotted line shows an example of a polynomial function which is fitted to the estimated number of remaining impressions data. At zero already printed impressions one statistical metric is chosen—in this instance the statistical metric is the average (mean), as represented by the closed circles. At a very high number of already printed impressions a different statistical metric is chosen—in this instance the statistical metric is the median, as represented by the open circles. For already printed impressions in between zero impressions and the very high number of printed impressions there is a linear interpolation between the two different statistical metrics, providing a smooth transition between them as the already printed impressions increases. For example the dashed line could be obtained by a linear weighing of mean and median with the weights depending on the already printed impressions. The function (the dotted line) can be calculated by the manufacturer or another external entity and stored in the memory of a printing device or in a cloud service. The function can be approximated by using a polynomial fit function and adjusting the coefficients of the polynomial until the dotted line corresponding to the function fits the dashed line shown in FIG. 6. The polynomial function then provides the formula to be used as the mapping information. The controller can then use the formula to provide an indication of an estimated number of remaining impressions that relates to a first statistical metric and another indication of an estimated number of remaining impressions, for another number of impressions printed, which relates to a second statistical metric.

FIG. 6 is just one example and other examples or underlying metrics and methods for deriving the formula are possible. For example, the metrics do not have to be the average and the median. Instead, the data points to which the function is fitted may be calculated to a higher or lower confidence level. The metrics may be any suitable centile or quantile. Moreover, the transition from one metric to another does not have to be smooth or provide continuity. Furthermore, a formula provided by the mapping information is not limited to providing indications relating to two metrics. In some examples, the formula may further provide an indication of an estimated number of remaining impressions that relates to a third or further statistical metric, for yet another number of impressions printed. Conversely, in some examples the function does not have to be derived from different metrics at different points in the lifespan of the component. Instead, the function may be fitted to data points that represent the same metric throughout the lifespan. Instead of a polynomial, another suitable base function may be used. A different formula may be stored for each replaceable component in the printing apparatus 100 stored in the memory 310 or on an external storage device, server, or cloud service. Moreover, different formulas to be used for different chosen confidence levels may be stored. For example, different coefficients may be stored for different confidence levels. The controller may obtain the coefficients to use for a particular confidence level or combination of confidence levels from a lookup table. Moreover, the function is shown with respect to the number of already printed impressions in FIG. 6 but the function may have more than one input variable or input parameter as indicated herein. Moreover, in some examples, the function may be derived taking various factors into account, such as the applications of the printing operations, print volume, historical start/stop patterns of the printing device and operator proficiency.

A look-up table would be derived in a similar way to that explained for the function but instead of fitting a polynomial to the dashed line, pairs of values at various points of the line, representing the normalized number of printed impressions and the normalized estimated number of remaining impressions are saved in the look-up table. By storing precomputed mapping information, precomputed for example as described above, and also precomputed adjusting data, the estimated number of remaining impressions can be obtained quickly in real-time.

As users stop replacing components far in advance of when the components would malfunction, the estimated number of remaining impressions for each number of already printed impressions may increase. This is because the lifespans for each component will increase as users replace them less frequently, and so the associated base information will show an increase in lifespans. An increase in lifespans may also occur as a result of improvements to printing processes or other components in the printing device. As the lifespans increase, the estimated number of remaining impressions will also increase for each number of already printed impressions. As such, the indication of an estimated number of remaining impressions provided by the formula will need to be updated. For at least some lifespan improvements, the formula can remain the same and updates to the estimated number of remaining impressions can be provided as the adjusting data for deriving the input or adjusting the output of the formula. For example, it can simply be provided as an update to the worldwide average lifespan LS_{ww} used in equation 1 above to derive an input to the formula. That way, the coefficients of the formula, or the entries in the look-up table, may not need to be updated every time the base information changes significantly. The manufacturer or other external entity may update the adjusting data and communicate the updated adjusting data to a printing device in the form of a software update, so that the updated formula may be stored in the memory of the printing device. Alternatively, information stored in a cloud service may be updated to include the updated adjusting data. Alternatively, if the manufacturer or other external entity want to make changes to the coefficients of the formula or changes to the look-up table, these can also be communicated in a similar way.

FIG. 7 is an example flowchart of an operating method for estimating the number of remaining impressions. With reference to FIG. 7 and FIGS. 1 and 2, a number of impressions already printed by the printing device 100 is determined in the printing device at 710. The determination is performed by the counter 210 using the sensor 144 located near the ITM drum 126. The number of impressions already printed is the number of impressions already printed by a particular component. In other words, the number of actual printing cycles in which the component has been involved. The counter transmits the number of impressions already printed to the controller 220.

The controller uses 220 the received number of impressions already printed by a component to obtain an estimate of a number of remaining impressions of the component at 720. The controller estimates the number of remaining impressions using the determined number of impressions already printed and information relating to lifespan performance of the component. The information relating to lifespan performance provides an indication of an estimated number of remaining impressions, for the number of impressions already printed, derived from statistical lifespan data selected in dependence on a lifespan threshold corresponding to the number of impressions already printed, as already described herein. As also already described herein, the information relating to lifespan performance may comprise predetermined mapping information providing a mapping between numbers of printed impressions and corresponding estimated numbers of remaining impressions. The mapping information may be derived from base information comprising statistical performance data for a plurality of printing devices. The mapping information provides the indication of an estimated number of remaining impressions. The mapping information may be provided in the form of a formula or look-up table stored in a memory 310. The information relating to lifespan performance of the component may further comprise adjusting data for deriving an input to and/or adjusting an output from the mapping information. The adjusting data may comprise printing device performance data. In more detail, obtaining the estimated number of remaining impressions of a component may comprise obtaining the indication of an estimated number of remaining impressions from the information relating to lifespan performance and adjusting the indication based on historical performance of the printing device to obtain the estimated number of remaining impressions. The adjusting data may alternatively or additionally comprise a statistical metric value, derived from the base information, for deriving an input to the mapping information.

The estimated number of remaining impressions is displayed on a display at 730. The controller 220 may control a display to show the estimated number of remaining impressions as part of a graphical user interface. In some examples, the method may comprise for each count of a counter counting the number of impressions already printed updating the estimated number of remaining impressions and displaying the updated estimated number of remaining impressions. When the component is replaced, the counter is reset and the method is then restarted for the new component. The method described in FIG. 7 may be computer-implemented.

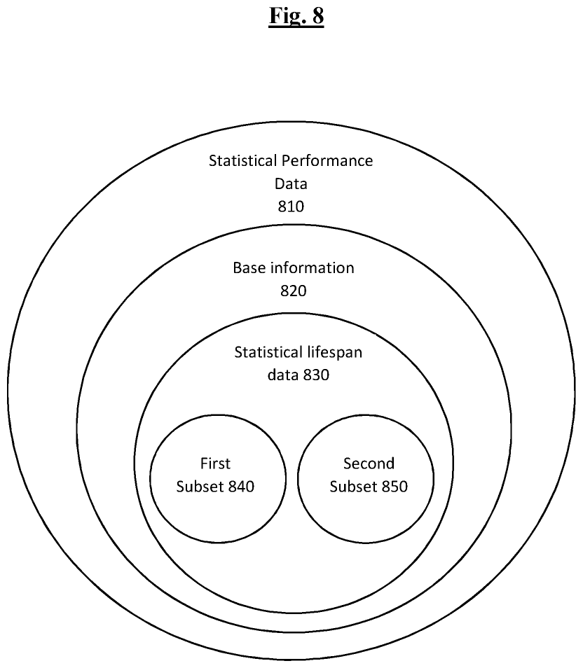

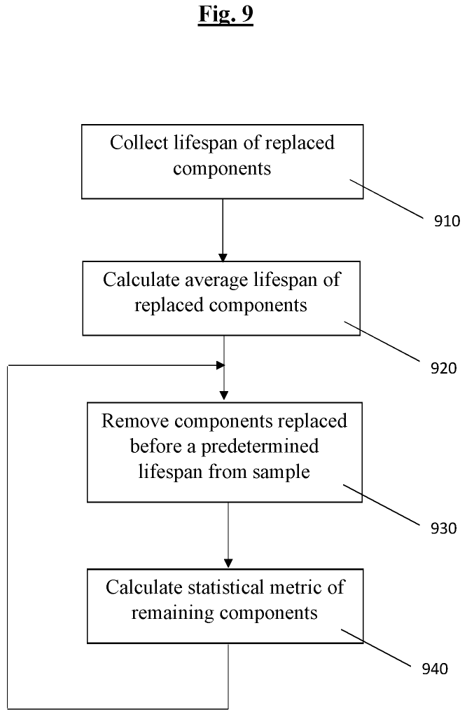

The calculation of the data points used to create the formula or look-up table and the data used for the calculation will now be described in more detail with respect to FIGS. 8 and 9. FIG. 8 demonstrates a relationship between some of the examples of data that can be used to estimate a number of remaining impressions of a component. The statistical performance data 810 relating to the statistical performance of a plurality of components of a printing device is obtained. The statistical performance data 810 may be obtained by collecting information regarding the performance of components from a plurality of printing devices throughout the world. As indicated above, the statistical performance data 810 may also comprise data regarding the performance of components obtained by undertaking experiments in a laboratory or factory environment. A subset of the statistical performance data 810 provides base information 820 for a particular component for use in a particular printing device model or a group of printing devices models having a number of common features. For example, the statistical performance data may comprise data relating to the performance of a plurality of BIDs, photoreceptors or blankets from a plurality of printing devices of a particular kind within a particular geographic area, wherein the geographic area may be worldwide, continent-wide, across a plurality of countries, across one country etc. It may be obtained from the entire install base of a number of similar printing devices or from part of the install base. The base information 820 comprises data relating to one of the plurality of components. For example, the base information may comprise data relating to just blankets, or just photoreceptors, or just BIDs. The base information may comprise data relating to just one particular model of one of the components.

To calculate a data point relating to an estimated number of remaining impressions for a particular number of already printed impressions, which can be used to derive the formula or for the look-up table, a subset of statistical lifespan data 840 is selected from the base information 820. Two subsets are shown by way of example in FIG. 8. The first subset 840 corresponds to selected statistical lifespan data for a component including lifespans of the component equal to or exceeding a threshold lifespan. That is, data for a component which did not reach a minimum lifespan threshold value may be excluded from the statistical lifespan data. An estimated number of remaining impressions derived from that first subset will then be presented to the user when the number of printed impressions reaches that minimum lifespan threshold. The second subset 850 corresponds to selected statistical lifespan data for a component including lifespans of the component equal to or exceeding a different threshold lifespan. That is, data for a component which did not reach a different minimum lifespan threshold value may be excluded from the statistical lifespan data. An estimated number of remaining impressions derived from the second subset will then be presented to the user when the number of already printed impressions reaches that different minimum lifespan threshold.

As mentioned above, the calculation of the estimated number of remaining impressions may use, in addition to the pre-computed mapping information in the form of a formula or look-up table, adjusting data comprising, for example, printing device performance data. The printing device performance data may be derived from statistical performance data from a particular printing device, which may be separate from the data graphically illustrated in FIG. 8. Alternatively, some of the data used to derive printing device performance data may form part of the data of FIG. 8.

FIG. 9 is an example flowchart of an operating method for calculating the conditional lifespan of a component. Data relating to the lifespan of components that have been replaced is collected at 910. The data may comprise lifespan data relating to all replaced components of a certain kind in a certain model or group of models of a printing device worldwide. This data forms the base information 820 of FIG. 8. The average lifespan of the replaced components is calculated at 920. The components which did not reach a minimum lifespan threshold value are removed from the statistics at 930. The remaining components form a subset such as the first subset 840 or the second subset 850 of the statistical lifespan data 830. A statistical metric of the remaining components which did reach the minimum lifespan threshold value is then calculated at 940. The statistical metric may be the average or another statistic of the subset sample. The calculated value is the conditional lifespan.

The conditional lifespans may then be calculated iteratively such that a different second minimum lifespan threshold value may be set and components removed from the sample if they did not reach the second threshold value at 930. The statistical metric of the remaining components may then be calculated at 940 for the new sample set to produce a conditional lifespan for the second minimum threshold value. By repeating operations 930 and 940 for different minimum lifespan thresholds values, the conditional lifespans for a plurality of numbers of impressions already printed can be obtained. The estimated number of remaining impressions can then be calculated by subtracting the number of impressions already printed from the conditional lifespan of the component. It is noted that the derivative of the estimated number of remaining impressions with respect to the already printed impressions is less than one. Therefore, if a user inspects the number of printed impressions and estimated number of remaining impressions at a time t0, and again at a later time t1, the estimated number of remaining impressions will have reduced by less than the number of impressions printed between times t0 and t1. The estimated numbers of remaining impressions and numbers of already printed impressions can then be further normalized or used directly as data points to obtain the mapping information to be stored or accessed by the printing device. At least operations 920, 930 and 940 of FIG. 9 can be computer-implemented. The collection of lifespan data may also be computer-implemented in that the printing devices may automatically send the number of printed impressions, determined by the counter, to a remote server when a component is replaced, together with identification information for the printing device and the component, and the server may store settings and instructions that allow it to categorize the information and add it to the appropriate base information.

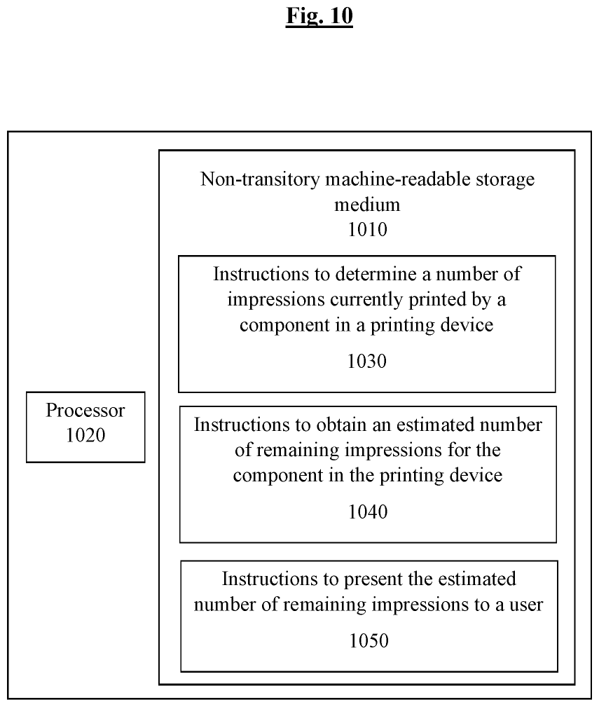

FIG. 10 illustrates a non-transitory machine-readable storage medium 1010 accessible by a processor 1020 to carry out a method in a printing device described herein according to an example. The processor may form part of the controller 220 described above with respect to, for example, FIGS. 2 and 3. At least a part of the non-transitory machine-readable storage medium may form at least a part of the memory 310 described above with respect to, for example, FIG. 3. The non-transitory machine readable storage medium 1010 is encoded with instructions that are executable by the processor 1020. The instructions comprise instructions 1030 to determine a number of impressions currently printed by a component of the printing device. The instructions also comprise instructions 1040 to obtain an estimated number of remaining impressions of a component in the printing device. Furthermore, the instructions also comprise instructions 1050 to present the estimated number of remaining impressions to a user. The storage medium may include any combination of suitable volatile memory and/or non-volatile memory, including, but not limited to, read-only memory (ROM), random access memory, cache, buffers, cloud storage etc. Although a single processor is shown, the storage medium may be shared among various processors or dedicated to particular processors. The storage medium may also comprise additional instructions and data for carrying out the method described.

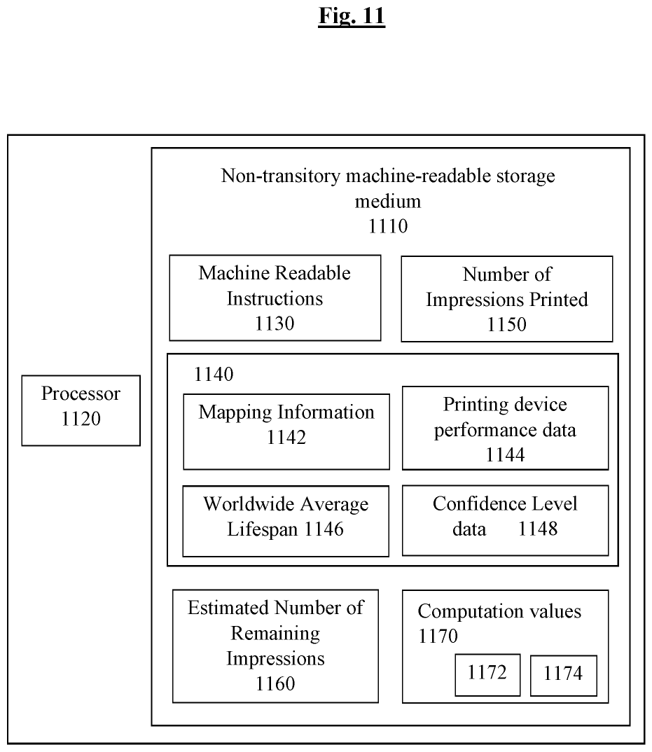

FIG. 11 shows another example of a non-transitory machine readable storage medium 1110, accessible by a processor 1120 for implementing the methods described above, comprising additional data and instructions. Non-transitory machine readable storage medium 1110 is encoded with instructions 1130 that are executable by the processor 1120. The storage medium 1110 may be the storage medium 1010 of FIG. 10 but, in addition to instructions corresponding to the instructions 1030, 1040, 1050 described with respect to FIG. 10, the non-transitory machine readable storage medium 1110 may also comprise, for example, instructions to provide the graphical user interface to present the estimated number of remaining impressions. Moreover, it may comprise instructions to present the number of impressions already printed to a user in addition to the estimated number of remaining impressions.

The non-transitory machine readable storage medium 1110 may further comprise a storage area for storing the information relating to lifespan performance 1140. The storage area may comprise a storage area for storing the mapping information 1142 such as a formula and/or a look-up table. Additionally, it may store the printing device performance data 1144 to adjust the output of the mapping information. Additionally, it may store a statistical metric to be used to derive the input to the mapping information. This may include, if there are more than one input parameter, it being used as one of those input parameters. For example, it may store a worldwide average lifespan 1146 as shown in FIG. 11. Additionally, confidence level data 1148 providing an input parameter to the mapping information or indicating specific mapping information if the mapping information comprises mapping information for different confidence levels may be stored. The confidence level data may comprise more than one confidence level value if the confidence level transitions from one statistical metric to another as the already printed impressions increases. As mentioned above, in some examples, the look-up table or formula may be derived to provide the transition from one statistical metric to another and the combination of confidence levels may be associated with a specific formula or look-up table. The processor 1120 would then access this stored information 1140 for analysis to determine an estimated number of remaining impressions of a component of a printing device.

The storage area may further store the number of impressions printed 1150 received from the counter and the estimated number of remaining impressions 1160 computed. Additionally, it may store a number of values 1170 used in the computation of the estimated number of remaining impressions, such as the input 1172 to the formula or look-up table and the output providing the indication of a number of remaining impressions 1174. As mentioned above, the input 1172 may be the number of printed impressions 1150 divided by the worldwide average lifespan 1146. These values 1170 may be temporarily stored in the memory of the storage medium until the next computation of an estimated number of remaining impressions at which time they are overwritten. Some of the data described with respect to FIGS. 10 and 11 may be stored in internal processor memory and some may be stored in external memory.

The storage medium may not store all the instructions and data described above and it may also store additional instructions and data. Moreover, if the printing device comprises more than one replaceable components, the data stored in memory will comprise data for each of the replaceable components.

The description of the various aspects and examples of the present disclosure has been presented for purposes of illustration and description, but is not intended to be exhaustive or to limit the disclosure to the forms disclosed. Any example of a feature or alternative described herein may be combined with any other example of a feature and alternative described, as appropriate, and the disclosure includes the various combinations and configurations of examples and alternatives.

For example, although it has been described that the adjusting data is updated and the mapping information remains the same, in some examples the mapping information may alternatively or additionally be updated and personalized. If the mapping information is a look-up table the entries in the look-up table may be updated. If the mapping information is a polynomial, the coefficients of the polynomial may be updated.

Although a specific implementation of the printing apparatus have been described with respect to FIG. 1, the printing apparatus can also be implemented in other ways and the methods and apparatus described herein can be used with other components. For example, although the printing apparatus has been described to comprise an ITM drum and a counter to receive signals from a sensor located near the ITM drum, the counter may receive signals from a sensor located near another component. Furthermore, the printing apparatus may comprise one or more belts, instead of one or more of the described drums, including a photosensitive belt instead of the impression drum. The printing apparatus may comprise a sensor located near one of the belts, in communication with the counter, to allow the counter to count the impressions printed. Although it has been described with respect to FIG. 1 that the printing apparatus creates the image on the print target using ink, this is just one example and the described method and apparatus can be used with components that use any suitable printing liquid or powder. It will be appreciated that the term printing device can comprise any 2D or 3D printing device, copier or multi-functional device.

What is claimed is:

1. Apparatus comprising:
a counter to determine a number of impressions already printed by a component in a printing device; and
a controller, coupled to the counter, to use the number of impressions already printed and information relating to lifespan performance of the component in a printing device, to determine an estimated number of remaining impressions for the component, and to communicate the estimated number of remaining impressions to a user, wherein the information relating to lifespan performance provides an indication of an estimated number of remaining impressions, for the number of impressions already printed, derived from statistical lifespan data selected in dependence on a lifespan threshold corresponding to the number of impressions already printed.

2. Apparatus according to claim 1, wherein the selected statistical lifespan data is selected from base information comprising statistical performance data for a plurality of printing devices.

3. The apparatus of claim 1, wherein the information relating to lifespan performance further comprises printing device performance data derived from historical performance data of the printing device and wherein the controller is to apply the printing device performance data to the indication of an estimated number of remaining impressions to obtain the estimated number of remaining impressions.

4. The apparatus of claim 2, wherein the information relating to lifespan performance further comprises a statistical metric value derived from the base information and wherein the controller is to use the statistical metric value to obtain the indication of an estimated number of remaining impressions.

5. The apparatus of claim 1, wherein the information relating to lifespan performance comprises information indicating a confidence level and the controller is to determine the estimated number of remaining impressions at the indicated confidence level.

6. The apparatus of claim 1, wherein the information relating to lifespan performance comprises predetermined mapping information providing the indication of an estimated number of remaining impressions, the predetermined mapping information comprising a formula and/or a look-up table having an input and an output and wherein the information relating to lifespan performance further comprises adjusting data to derive the input from the number of impressions already printed and/or to apply to the output in order to obtain the estimated number of remaining impressions.

7. The apparatus of claim 2, wherein the indication of an estimated number of remaining impressions relates to a first statistical metric and the information relating to lifespan performance provides another indication of an estimated number of remaining impressions, for another number of impressions printed, which relates to a second statistical metric, wherein the first statistical metric is a different statistical metric to the second statistical metric.

8. A printing device comprising:
the apparatus of claim 1;
a memory, coupled to the controller, to store the information relating to lifespan performance of the component; and
an interface to receive update information to update the information relating to the lifespan performance of the component.

9. A method comprising:
determining in a printing device a number of impressions printed by a component in the printing device;
obtaining an estimated number of remaining impressions for the component in the printing device from the number of impressions already printed and information relating to lifespan performance of the component; and
displaying the estimated number of remaining impressions to a user,
wherein the information relating to lifespan performance provides an indication of an estimated number of remaining impressions, for the number of impressions already printed, derived from statistical lifespan data selected in dependence on a lifespan threshold corresponding to the number of impressions printed.

10. A method of claim 9, wherein the information relating to lifespan performance comprises mapping information providing the indication of an estimated number of remaining impressions, the mapping information being derived from base information comprising statistical performance data for a plurality of printing devices.

11. The method of claim 10, wherein the information relating to lifespan performance further comprises adjusting data for deriving an input to and/or adjusting an output from the mapping information.

12. The method of claim 9, wherein obtaining the estimated number of remaining impressions of a component in the printing device comprises determining the indication of an estimated number of remaining impressions from the information relating to lifespan performance and adjusting the indication based on historical performance of the printing device to obtain the estimated number of remaining impressions.

13. The method of claim 11, wherein the adjusting data comprises a statistical metric value, derived from the base information, to derive an input to the mapping information.

14. A method according to claim 10, wherein determining the number of impressions printed by a component comprises counting the number of impressions using a counter and wherein obtaining and displaying the estimated number of remaining impressions comprise for each count of the counter updating the estimated number of remaining impressions and displaying the updated estimated number of remaining impressions.

15. A non-transitory machine-readable storage medium encoded with instructions executable by a processor, the machine-readable storage medium comprising:
instructions to determine a number of impressions currently printed by a component in a printing device;
instructions to obtain an estimated number of remaining impressions for the component in the printing device based on the number of impressions currently printed and information relating to lifespan performance for the component, the information relating to lifespan performance providing an indication of an estimated number of remaining impressions, for the number of impressions already printed, derived from statistical lifespan data selected in dependence on a lifespan threshold corresponding to the number of impressions already printed; and
instructions to present the estimated number of remaining impressions to a user.
